(19) United States
(12) Patent Application Publication
(10) Pub. No.: US 2025/0189997 A1
(43) Pub. Date: Jun. 12, 2025

(54) ADAPTER INSERT AND FLOW REGULATING ELEMENT FOR A CONTROL VALVE FOR FORMING A STEAM CONVERTER, STEAM CONVERTER AND CONTROL VALVE EQUIPPED THEREWITH

(71) Applicant: Samson Aktiengesellschaft, Frankfurt am Main (DE)

(72) Inventors: Alexander Miller, Frankfurt Am Main (DE); Hartmut Neuheuser, Seck (DE); Johannes Jantz, Schmitten (DE)

(73) Assignee: Samson Aktiengesellschaft, Frankfurt am Main (DE)

(21) Appl. No.: 18/973,935

(22) Filed: Dec. 9, 2024

(30) Foreign Application Priority Data
Dec. 11, 2023 (DE) 102023134638.5

(51) Int. Cl. G05D 7/01; F16K 27/02

(52) U.S. Cl. CPC G05D 7/0133; F16K 27/02

(57) ABSTRACT

An adapter insert for a control valve of a process plant for forming a steam converter may include an insert body with a distance extension section configured to be arranged between a valve housing and a housing cover or between the valve housing and a lantern of the control valve. The distance extension section may include a fluid inlet connection opening, which, in an assembled state of the adapter insert, is located at least sectionally between the valve housing and the housing cover or between the valve housing and the lantern of the control valve.

### CROSS REFERENCE TO RELATED APPLICATIONS

This patent application claims priority to German Patent Application No. 10 2023 134 638.5, filed Dec. 11, 2023, which is incorporated herein by reference in its entirety.

### BACKGROUND

### Field

The present disclosure relates to an adapter insert and a flow regulating element for a control valve of a process plant, such as a chemical plant, a power plant, a food processing plant, or the like, for forming a steam converter, as well as a steam converter and also a corresponding control valve, in particular equipped therewith.

### Related Art

Document US 2023 0 167 917 A1 shows a valve control assembly comprising a valve body having an inlet connectable to a source of process fluid having a first temperature, an outlet and a fluid flow path extending between the inlet and the outlet, and a bonnet connected to the valve body. An inlet port, an outlet port, an annular plenum, an inlet passage and an outlet passage are integrally formed in the valve body or bonnet. The inlet port may be connected to a source of media, and the annular plenum is disposed between the inlet port and the outlet port, immediately adjacent a portion of the fluid flow path. The inlet port directs the fluid from the inlet port to the annular plenum, thereby changing the temperature of the process fluid flowing through the fluid flow path from the first temperature to a second temperature that is different from the first temperature. The fluid flow path and the annular plenum are thus integrally arranged in the valve body or bonnet, which is both complex to produce and requires a specially manufactured valve body or bonnet. This also leads to increased manufacturing costs.

A steam converter formed by a control valve is known, for example, from DE 19 635 464 B4. The valve is designed for a hot steam conversion station and comprises a valve housing which has an inlet and an outlet connection piece and is provided with a valve seat which interacts with a closure member which can be moved via an actuating rod relative to the valve seat from a sealing closed position to an open position and vice versa. The closure member and the valve housing are shaped in such a way that they form a chamber which, when the closure member is opened to the outlet nozzle is initially not or not completely opened and from which a steam branch channel branches off, which opens into the outlet connection piece in the outlet area of a water injection device. The steam branch channel comprises at least an inlet opening in the closure member which extends through the actuating rod into a sealed transfer space between the actuating rod and the valve housing, from which it reaches via at least one housing bore the mouth region of the water injection device.

However, the construction according to DE 19 635 464 B4 is complex and expensive, as there are a large number of channels that extend through several components of the control valve. This makes the arrangement incompatible with other valves and makes assembly more difficult. For example, there may be additional restrictions at the installation site, for example with regard to an installation space, which makes installation complex and/or time-consuming due to the fixed arrangement of the components.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 shows a conventional separate steam converter, for example a special control valve or steam converter valve;

FIG. 2 shows a control valve that is equipped with an adapter insert according to the disclosure and a flow regulating element according to the disclosure;

FIG. 3 shows a control valve that is equipped with a further adapter insert according to the disclosure and a flow regulating element according to the disclosure;

FIG. 4 shows a control valve equipped with a further adapter insert according to the disclosure and a flow regulating element according to the disclosure;

FIG. 5 shows a control valve that is equipped with a further adapter insert according to the disclosure and a flow regulating element according to the disclosure;

FIG. 6 shows a flow regulating element according to the disclosure;

FIG. 7A shows a further flow regulating element according to the disclosure; and

FIG. 7B shows a side view of the further flow regulating element of FIG. 7A according to the disclosure.

The exemplary embodiments of the present disclosure will be described with reference to the accompanying drawings. Elements, features and components that are identical, functionally identical and have the same effect are-insofar as is not stated otherwise-respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, and components have not been described in detail to avoid unnecessarily obscuring embodiments of the disclosure.

The drawings are schematic drawings that are not to scale. Some elements in the drawings may have exaggerated dimensions to emphasize aspects of the present disclosure and/or for better presentation clarity. For simplicity, identical reference signs are used to indicate identical elements, which are commonly included in the drawings. It is provided that elements and features of one embodiment may advantageously be incorporated into other embodiments without further mention. In general, only the differences with respect to individual embodiments are described.

Each embodiment is designed to explain the disclosure and is not intended to be limiting of the disclosure. In addition, features shown or described as part of one embodiment may be used in conjunction with other embodiments to create another embodiment. It is intended that the description include such modifications and variations.

It is the object of the present disclosure to overcome the disadvantages of the conventional techniques and, in particular, to provide an improved adapter insert and an improved flow regulating element for forming a steam converter, as well as an improved steam converter for a control valve and a corresponding improved control valve.

The disclosure relates to an adapter insert for a modular control valve of a process plant, such as a chemical plant, a power plant, a food processing plant, or the like, for forming a steam converter. The adapter may comprise:
an insert body with a distance extension section for arrangement between a valve housing and a housing cover or between the valve housing and a lantern of the control valve, wherein the distance extension section comprises a fluid inlet connection opening, in particular for reception of a connection piece, which, in the assembled state of the adapter insert, is located at least sectionally between the valve housing and the housing cover or between the valve housing and the lantern of the control valve.

The disclosure relates to an adapter insert for a modular control valve of a process plant, such as a chemical plant, a power plant, a food processing plant, or the like, for forming a steam converter, in particular according to one or more of the aspects and/or embodiments of the disclosure described herein. The adapter insert may comprise:
an insert body with a distance extension section for arrangement between a valve housing and a housing cover or between the valve housing and a lantern of the control valve,
wherein the insert body forms a fluid collection chamber which, in the assembled state of the adapter insert, extends at least sectionally between the valve housing and the housing cover or the valve housing and the lantern of the control valve.

The disclosure relates to an adapter insert for a modular control valve of a process plant, such as a chemical plant, a power plant, a food processing plant, or the like, for forming a steam converter, in particular according to one or more of the aspects and/or embodiments of the disclosure described herein. The adapter may comprise:
an insert body with a distance extension section for arrangement between a valve housing and a housing cover or between the valve housing and a lantern of the control valve.

The insert body may comprise at least one fluid passage channel which extends from a fluid collection chamber to at least one inlet opening of a, in particular substantially sleeve-shaped, flow regulating element, in particular according to one or more of the aspects and/or embodiments of the disclosure described herein, for distribution of fluid, in particular directly and/or without interruption.

The disclosure relates to a flow regulating element, for connection to an adapter insert, in particular according to one or more of the aspects and/or embodiments of the disclosure described herein, for a modular control valve of a process plant, such as a chemical plant, a power plant, a food processing plant, or the like, for forming a steam converter. The flow regulating element may comprise:
a substantially sleeve-shaped throttle body for distribution of fluid with at least one fluid distribution channel,
wherein the at least one fluid distribution channel extends at least partially in the axial direction of the substantially sleeve-shaped throttle body, in particular almost over an entire, in particular axial, height of the substantially sleeve-shaped throttle body, and leads into at least one throttle channel.

The disclosure relates to a flow regulating element, in particular according to one or more of the aspects and/or embodiments of the disclosure described herein, for connection with an adapter insert, in particular according to one or more of the aspects and/or embodiments of the disclosure described herein, for a modular control valve of a process plant, such as a chemical plant, a power plant, a food processing plant, or the like, for forming a steam converter. The flow regulating element may comprise:
a substantially sleeve-shaped throttle body for distribution of fluid,
wherein the substantially sleeve-shaped throttle body comprises at least two sleeves, in particular arranged concentrically to one another, with at least one inner sleeve and an outer sleeve, in particular surrounding the same.

The disclosure relates to a steam converter for a modular control valve of a process plant, such as a chemical plant, a power plant, a food processing plant, or the like. The steam converter may comprise:
an adapter insert according to one or more of the aspects and/or embodiments of the disclosure described herein, and
a flow regulating element, in particular connected thereto, according to one or more of the aspects and/or embodiments of the disclosure described herein.

The disclosure relates to a modular control valve of a process plant, such as a chemical plant, a power plant, a food processing plant, or the like. The modular control valve may comprise:
a valve housing with an inlet opening and an outlet opening, as well as a passage opening arranged therebetween;
a housing cover with a through-opening arranged opposite the passage opening;
optionally, a coupling structure, in particular a lantern, between the valve housing and the housing cover;
an adapter insert according to one or more of the aspects and/or embodiments of the disclosure described herein; and/or
a flow regulating element, according to one or more of the aspects and/or embodiments of the disclosure described herein; and
a steam converter according to one or more of the aspects and/or embodiments of the disclosure described herein.

When reference is made herein to the adapter insert, the flow regulating element, the steam converter or the control valve, this refers to the adapter insert according to the disclosure, the flow regulating element according to the disclosure, the steam converter according to the disclosure or the control valve according to the disclosure.

In a first embodiment of the disclosure, an adapter insert is provided for a modular control valve of a process plant, such as a chemical plant, a power plant, a food processing plant, or the like, for forming a steam converter.

An “adapter insert” can be understood herein as an apparatus, assembly, part, component, element and/or device that can create, provide and/or establish a, in particular mechanical, interface and/or connection, between different, for example two, (component) parts or components, for example a valve housing, a housing cover and/or a coupling structure, in particular a lantern. The term “insert” can be understood to mean that the adapter is designed and/or configured to connect to a (component) part or component, for example to be placed, inserted, inlaid, deployed and/or integrated therein, for example in a form-complementary and/or form-fit manner, and/or can at least engage and/or interfere with it, for example in a form-complementary and/or form-fit manner. This can also describe, for example, the act of installing and/or mounting the adapter, for example, on the valve housing, the housing cover and/or the lantern. For example, the adapter insert can have one side or coupling surface that can engage with a valve housing and another side or coupling surface opposite to it that can engage with a housing cover and/or a lantern, wherein the two sides or coupling surfaces can be formed to be correspondingly form-complementary and/or form-fit. The adapter insert can therefore be configured and/or formed for connecting or attaching between the valve housing and the housing cover and/or the lantern, wherein the adapter insert can be held, attached and/or fixed, for example, in a force-locking manner between the valve housing and the housing cover or between the valve housing and the lantern. The adapter insert can be compatible with a plurality of valve housings, housing covers and/or lanterns, which increases flexibility and/or modularity.

A “steam converter” can be understood herein as a means, element, apparatus and/or device which can turn, transform, convert and/or reform energy, e.g. of a steam flow, into, in particular, mechanical energy or a, in particular, mechanical movability. Conversion to perform mechanical work is also possible.

In process plants that work with steam, steam may be present in an overheated form after an intermediate process. This overheated steam can be used to perform mechanical work, for example in a turbine system where the steam is led through nozzles that are in turn directed at the turbine's rotor blades. However, other applications are also conceivable, such as in the producing and processing of oil and/or petroleum, and also a production as a by-product.

In applications with heat transfer, however, overheated steam is not as effective as saturated steam. Therefore, a transfer, e.g. cooling, may be desired or required depending on the application. “Saturated steam” can refer to steam that is in a thermodynamic equilibrium with its liquid phase, for example an equilibrium of evaporation of water and its condensation. In a pressure-temperature diagram in which the pressure is plotted on the x-axis, for example, and the temperature on the y-axis, for example, this can be described by a so-called saturated steam curve. Overheated steam can be described as steam, e.g. saturated steam, to which further energy has been fed in the form of heat. Overheated steam can, for example, have a higher temperature and lower density than saturated steam at the same pressure, e.g. lie above the saturated steam curve.

A steam converter can regulate or reduce the pressure and temperature to corresponding setpoints. The overheated steam can be deformed by a steam converter, for example, the overheated steam can be brought into connection and/or contact with a fluid, e.g. water or cooling water, whereby it can be cooled and thus a throttling effect can be generated. It is possible to measure the escaping steam flow, e.g. after the steam converter (e.g. pressure, temperature, etc.) and to use this information, parameters and/or measured values for further control, for example of a fluid inflow, e.g. of the cooling water and/or of a pressure, e.g. for a valve position.

According to the disclosure, the adapter insert is adapted and/or configured “for forming a steam converter.” This can be understood to mean that the adapter insert acts as a steam converter without, for example, providing a separate steam converter, for example a special control valve or steam converter valve. The adapter insert can therefore form, shape and/or provide the steam converter itself, e.g. in the modular control valve. This eliminates the need for special control valves, which not only reduces costs but also simplifies producing. Typically, the provision of a steam converter in a control valve requires at least the adaptation, alteration, conversion and/or modification of the valve housing, the housing cover and/or the lantern of the control valve. The adapter insert according to the disclosure makes it possible to use the valve housing, the housing cover and/or the lantern of the control valve without such adaptations. In this way, a modular design is advantageously realized, since the adapter insert can be compatible with a plurality of valve housings, housing covers and/or lanterns of control valves, and can be inserted therein accordingly. This also enables one or more, e.g. different, components, parts and/or elements to be combined, assembled and/or exchanged, e.g. as required. For example, individual components, parts and/or elements can be easily installed and/or removed, replaced and/or renewed by the adapter insert according to the disclosure, e.g. for maintenance purposes. This saves resources and time and enables greater flexibility. A control valve that is equipped with the adapter insert according to the disclosure, for example, can be referred to as a modular control valve.

The control valve can comprise a valve housing and a housing cover. The valve housing may comprise an inlet opening and an outlet opening as well as a passage opening arranged therebetween. The control valve may also comprise a valve seat which may surround the passage opening. The valve seat may be fully circular. Furthermore, the control valve can comprise a control element that is movable in the valve housing and can be attached to a control rod. The control element can be brought into sealing engagement with the valve seat. The valve seat and the control element can be matched to one another for sealing engagement. The housing cover can have a through-opening for the control rod. The housing cover can be arranged opposite the passage opening. The housing cover can be attached or attachable to the valve housing. The control valve can comprise a control element that is translationally movable along a stroke axis, such as a stroke valve element, for example a valve piston or valve plug. The control element can be configured to adjust a process fluid flow in a process plant.

The valve housing, which can also be referred to as the housing body, can have a process fluid inlet, a process fluid outlet and a process fluid passageway arranged between the process fluid inlet and the process fluid outlet. Furthermore, the housing body may comprise an actuation opening for inserting the control element and/or a control rod for actuating the control element along the stroke axis. At the process fluid inlet and at the process fluid outlet of the valve body, mounting devices, for example flange-like attachment sections, can be provided for connecting a pipeline for guiding the process fluid. A valve seat can be provided on the process fluid passage of the valve housing, which can cooperate with the control element in a closing and/or opening manner. The valve seat can be an annular and/or sleeve-shaped seat of an insertable component. The valve seat can have one or more sealing surfaces for sealing cooperation with the control element, in particular a valve piston or valve cone. One (or more) sealing devices, such as a ring seal, can be arranged between the valve seat and the valve housing.

The valve housing can be a in particular one-piece body made of one or more media- and/or temperature-resistant materials. For example, the valve housing can be a one-piece cast metal body or forged body which is sectionally coated with a machined, for example polished and/or coated, for example painted, powder-coated, chrome-plated, enameled, galvanized or similar, surface. The valve housing may define an internal housing space, the openings of which may be realized exclusively by the process fluid inlet, the process fluid outlet and the actuation opening. It is conceivable that a housing body has further openings to the inner space, for example openings for the introduction of sensors or one or more further process fluid inlets or outlets.

The housing cover may be arranged and configured to cover the actuating opening. The housing cover can have a through-opening extending in the direction of the stroke axis for receiving the control rod. In particular, the housing cover can comprise an attachment section for mounting an actuator, in particular a pneumatic actuator, or a yoke, a coupling structure, in particular a lantern or the like for supporting an actuator. A corresponding attachment section can also be provided on the valve housing. The through-opening can be free of sealing means for sealing between the housing cover and the control rod or the pre-mountable control rod assembly. The through-opening can be free of guides, such as a plain bearing, a ball bearing or the like, for translationally guiding the control element. With regard to a control rod, the housing cover can be dimensioned in such a way that the smallest clear width, in particular the smallest inner diameter, of the housing cover, in particular the through-opening, is at least 1 mm or at least 5 mm larger than the outer diameter of the control rod in the region extending through the through-opening of the housing cover. The housing cover can be formed from a temperature- and/or media-resistant material. It is conceivable that the same material is selected for the valve housing and the housing cover. The housing cover and the valve housing can be designed for mounting the housing cover in direct contact with the housing body. For example, the housing body and the housing cover can have corresponding flange sections for attaching the housing cover to the housing body. A coupling structure, in particular a lantern, can also be provided between them, but this is not mandatory. The housing cover can have a plate-like cover section, which may be designed to completely close the actuation opening of the valve housing in the radial direction and in the circumferential direction with respect to the stroke axis, with the exception of the through-opening.

The control valves of the process plant can be embodiments according to the disclosure in various ways, i.e. the control valves need not be identical. In particular, the process plant can comprise a plurality of control valves according to the disclosure with similar valve housings, housing covers, mounting flanges, coupling structures, in particular lanterns (if present), and/or different types of insert sleeves and/or control elements. The disclosure can also comprise a set of process control valves for one or more process plants, which has a plurality of similar valve housings, a plurality of similar housing covers, a plurality of similar coupling structures, in particular lanterns (if present), and/or a plurality of similar mounting flanges, and/or a plurality of different insert sleeves and/or a plurality of different control elements.

The process plant with several control valves can comprise at least two different, in particular similar, mounting flanges and/or two different insert sleeves and/or two different control elements, wherein the insert sleeves of the several control valves can be inserted alternately into the different mounting flanges.

Where reference is made herein to a substantially “vertical” or “perpendicular” direction, this may refer to a direction which may substantially correspond to the direction of the stroke axis of the control valve and/or the direction of gravity, and where reference is made herein to a substantially “horizontal” or “transverse” direction, this may refer to a direction which may substantially correspond to a direction transversely to the direction of the stroke axis and/or the direction of gravity. Otherwise, explicit reference can be made to corresponding, e.g. other, directions.

The adapter insert according to the disclosure can comprise an insert body with a distance extension section for arrangement between a valve housing and a housing cover or between the valve housing and a lantern of the control valve.

An “insert body” can define and/or form the main body and/or the main component of the adapter insert and can, for example, be formed in one piece, for example from metal. In an exemplary embodiment, the insert body has the same material as the valve body and/or the housing cover and/or the lantern. An “insert” of the body can be understood as an act of placing, arranging, inserting, including, deploying, integrating and/or at least engaging and/or interfering, for example in a form-complementary and/or form-fit manner, in/with a (component) part or a component of the control valve, e.g. the valve housing, the housing cover and/or the lantern. In this way, a modular design is advantageously realized, since the insert body can be compatible with a plurality of valve housings, housing covers and/or lanterns of control valves, and can be inserted therein accordingly. This can be realized, for example, via corresponding coupling surfaces described herein.

The insert body and/or the adapter insert can be formed and/or constructed substantially rotationally symmetrical, for example substantially annular, sleeve-shaped and/or substantially (hollow) cylindrical. This rotationally symmetrical shape makes it possible, for example, to align or adjust, such as rotate, the insert body or the adapter insert in the circumferential direction, e.g. after insertion or insertion into the valve housing. In other words, the insert body or the adapter insert can, for example, be configured to be rotatable, in particular in the circumferential direction (e.g. by 360° or more/less), such as in an inserted state in the valve housing. The same applies to the lantern and/or the housing cover, for example when the insert body or the adapter insert is inserted therein. For example, a fluid inlet connection opening described herein and possibly arranged/formed therein can be aligned, rotated and/or adjusted in a simple manner, for example during and/or also after assembly. This makes it possible, for example in the circumferential direction, to provide several different settings, positions and/or orientations, which, among other things, increases flexibility and saves time during assembly. This means that the position of a water connection, for example, can be freely selected, particularly in the circumferential direction, and can be adjusted accordingly if required. The adapter insert and/or the insert body can be formed in one piece and/or in layers and/or produced in one piece, such as using a 3D printing process. This makes it possible, for example, to produce more complex geometries easily and cost-effectively.

A “distance extension section” can be a portion, a section and/or a region of the insert body which is at least adapted and/or configured to produce, provide and/or create a spacing, in particular an interspace, a gap and/or a distance (wherein these terms can be used interchangeably herein) between the valve body and the housing cover or between the valve body and the lantern of the control valve. The distance extension section can, for example, be flange-like and/or plate-like in shape and/or be connected to the insert body. For example, the distance extension section, in particular in an inserted state, can increase, widen, raise and/or lengthen the spacing between the valve housing and the housing cover or between the valve housing and the lantern of the control valve. For this purpose, the distance extension section can be arranged, inserted, inlaid, deployed and/or pushed in between the valve housing and the housing cover or between the valve housing and the lantern of the control valve. The distance extension section can be integrally connected to or formed by the insert body, in particular in one piece, or separately, e.g. as an individual component that is attached and/or attachable to the insert body. The distance extension section may be produced from the same material as the insert body or the adapter insert, for example metal.

The distance extension section can have a coupling surface which is formed complementary in shape to the valve housing and another coupling surface, in particular opposite thereto, which is formed complementary in shape to the housing cover or the lantern. The two coupling surfaces can be substantially opposite each other in the direction of the stroke axis, e.g. in the vertical direction. Optional sealing elements (e.g. one or more) can be used on the coupling surfaces. For example, at least one sealing means, in particular a ring seal, may be present or inserted between the coupling surface of the distance extension section and the valve housing and/or at least one sealing means, in particular a ring seal, may be present or inserted between the other coupling surface of the distance extension section and the housing cover or the lantern. The fluid inlet connection opening described herein may, for example, be located, extend and/or run between the two coupling surfaces, in particular at least sectionally and/or at least partially.

The distance extension section can be configured, formed and/or dimensioned, in particular in the assembled state of the adapter insert, to form a spacing, in particular an interspace, between the valve housing and the housing cover or the valve housing and the lantern in the range of at least approximately 2 cm. A spacing of at least approximately 1.5 cm, preferably at least approximately 1 cm, would also be possible. As already mentioned, the distance extension section can, for example, be formed in a flange-like and/or plate-like manner, i.e. a thickness or height of the distance extension section, in particular in the direction of the stroke axis, can, for example, correspond at least approximately 2 times to a diameter of the connection tube or the connection piece. The connecting tube can, for example, be provided substantially in the center of the distance extension section. A minimum thickness or height of the distance extension section can therefore be provided above or below (in particular in the direction of the stroke axis) the connecting tube. For example, the following relation can be used for this [(“height D” minus “diameter of connecting tube”)/2]. For example, a distance in the direction of the stroke axis can be provided in the range of at least approximately 5 mm above and below the connecting tube, for example on both sides of the connecting tube.

According to the disclosure, the distance extension section may comprise and/or form a connection opening which may be designed as a fluid inlet and/or for producing a fluid connection and which may be referred to herein as a fluid inlet connection opening. A fluid inlet may be a location, section, portion, place and/or position, for example at or in the distance extension section and/or the insert body, at which a fluid, for example water, may enter, penetrate and/or reach and/or be led into the control valve, for example the valve body.

A “connection opening” can be understood as an opening, a hole, an inlet, an entrance and/or a channel, such as a through channel, for the fluid, for example water. The connection opening can be connectable to a connection piece (e.g., detachable). The fluid inlet connection opening may be formed as a fluid inlet channel. A connection piece can be a, e.g. substantially tubular, apparatus which enables the connection opening to be connected to a fluid reservoir, a fluid source, for example a water source, a fluid supply device, in particular a water connection, in particular directly, detachably and/or leak-free. The connection piece can be produced from various materials, for example metal, e.g. stainless steel, or plastic, and can be attached and/or attachable to the connection opening, for example by means of a thread, a flange or a hose connection. The cross-section of the “connection opening” can be variable, e.g. round or square. The fluid supply device, in particular the water connection, and/or the connection piece, can extend between the valve housing and the housing cover or the valve housing and the lantern of the control valve, in particular substantially transversely to a stroke axis of the control valve, in particular in the assembled state. The fluid supply device, in particular the water connection, and/or the connection piece can be rotatable and/or alignable during an assembly, in particular by the adapter insert, in particular in the circumferential direction, in particular by 360°, for example (e.g. by 360° or more/less). For example, the fluid supply device, in particular the water connection, and/or the connection piece, can be easily aligned, rotated and/or adjusted, for example during and/or after assembly. This enables several different positions, e.g. in the circumferential direction, which increases flexibility and saves time during assembly, among other things. This means that the position of a water connection, for example, is freely selectable and/or changeable/adjustable. It is also conceivable to simply loosen the fastening between the housing cover and the valve housing (or the lantern, if this is used) in order to rotate the adapter insert and/or align the fluid supply device, in particular the water connection, and/or the connection piece.

The fluid inlet connection opening can, in the assembled state of the adapter insert, be located at least sectionally between the valve housing and the housing cover or between the valve housing and the lantern of the control valve.

An assembled state may already be reached, for example, if the adapter insert and/or the insert body is merely inserted and/or deployed in the valve housing, for example before the housing cover is mounted, connected and/or attached or even after the housing cover is mounted, connected and/or attached. A loosened state, as mentioned above, can also describe an assembled state. The fluid inlet connection opening can, in the assembled state of the adapter insert, be located, in particular in the vertical direction, e.g. as mentioned above in the direction of the stroke axis, at least sectionally or substantially completely between the valve housing and the housing cover or between the valve housing and the lantern of the control valve.

It is also possible that the fluid inlet connection opening is arranged offset with respect to the spacing, in particular the interspace, which is defined and/or formed, in particular by the distance extension section, between the valve housing and the housing cover or between the valve housing and the lantern of the control valve. A diameter of the fluid inlet connection opening may be formed smaller than the spacing, in particular the interspace, which is defined and/or formed, in particular by the distance extension section, between the valve housing and the housing cover or between the valve housing and the lantern of the control valve. In this way, the fluid inlet connection opening can be arranged substantially completely in between or offset.

The spacing, in particular the interspace, which is defined and/or formed, in particular by the distance extension section, between the valve housing and the housing cover or between the valve housing and the lantern of the control valve, can be matched to a size, in particular a diameter, of a connection piece and/or a fluid supply device. For example, the spacing, in particular the interspace, can be at least large enough to enable a connection of the connection piece and/or the fluid supply device. An exemplary diameter of the connection piece may be in the range of approximately 15-55 mm, preferably approximately 0.5 inches, e.g. approximately 13 mm to approximately 2 inches, e.g. approximately 51 mm.

The fluid inlet connection opening can extend through the adapter insert, in particular the insert body and/or the distance extension section, for example completely through or at least partially through. The fluid inlet connection opening may extend in at least one direction, such as in several directions, and/or may also extend, for example, at an angle, inclined, bent, curved and/or kinked. The fluid inlet connection opening can, for example, extend at least partially in a radial or horizontal direction of the adapter insert, in particular substantially transversely to a stroke axis of the control valve. In an exemplary embodiment, the fluid inlet connection opening can extend substantially completely or entirely through the insert body, in particular the distance extension section. For example, the fluid inlet connection opening can in this way create and/or provide a fluid connection to an interior, an inner space or an inner region of the control valve, for example the valve housing.

The fluid inlet connection opening is alignable, by rotating the adapter insert and/or the insert body, in particular during or after assembly, in particular in the circumferential direction, in particular by 360° (or more/less). It is possible, for example, to rotate the adapter insert and/or the insert body even after assembly, for example by loosening or partially loosening the attachment between the valve housing and the housing cover/lantern. For example, a fluid inlet connection opening described herein and arranged/formed therein can be easily aligned, rotated and/or adjusted, e.g. during and/or after assembly. This enables several different positions, e.g. in the circumferential direction, which, among other things, increases flexibility and saves time during assembly. In this sense, the fluid inlet connection opening, the adapter insert and/or the insert body can therefore be configured and/or designed to be rotatable, pivotable, alignable and/or adjustable. This allows the position of a water connection, for example, to be freely selectable.

In a second embodiment of the disclosure, which can be combined with one or more of the aspects and/or embodiments of the disclosure described herein, an adapter insert is provided for a modular control valve of a process plant, such as a chemical plant, a power plant, a food processing plant, or the like, for forming a steam converter.

The adapter insert according to the disclosure can comprise an insert body with a distance extension section for arrangement between a valve housing and a housing cover or between the valve housing and a lantern of the control valve.

The insert body can form a fluid collection chamber which, in the assembled state of the adapter insert, extends at least sectionally between the valve housing and the housing cover or the valve housing and the lantern of the control valve. The insert body can at least partially form the fluid collection chamber, e.g. a chamber that is not necessarily completely enclosed by the insert body. It is also possible that the fluid collection chamber is partially formed by/in the distance extension section. The fluid collection chamber can therefore be formed in one piece and/or integrally with the insert body and/or the distance extension section, such as by means of a 3D printing process and/or formed in layers. This enables the producing of complex geometries in a comparatively simple manner. It is also conceivable that the fluid collection chamber is constructed in several parts, e.g. partially formed by the insert body and/or the distance extension section and in conjunction with another or further element, part and/or another or further structure forms or shapes the fluid collection chamber.

A “fluid collection chamber” herein may refer to a space, such as a cavity, chamber or compartment, which may be designed to receive, collect, contain and/or hold a fluid, such as water, for example as a temporary intermediate storage. A fluid collection chamber may comprise an inlet and an outlet. For example, the fluid inlet connection opening described herein may form an inlet of the fluid collection chamber and/or the fluid inlet connection opening described herein may, for example, lead into the fluid collection chamber, in particular directly and/or without interruption.

“Directly and/or without interruption” can be understood herein to mean that a fluid can be led, for example, directly to or into a corresponding section or region, for example to or into a corresponding cavity, such as a chamber, i.e. without first passing through, for example, any intermediate chambers or other cavities in between. In this context, corresponding channels described herein (e.g., the fluid inlet connection opening, the fluid passage channel, etc.) could also be referred to as a continuous channel or continuous channels, e.g., having substantially uniform and/or constant cross-section, wherein they may, for example, directly connect to the corresponding chamber.

The fluid collection chamber can extend in the circumferential direction of the adapter insert (and/or the insert body), in particular around a stroke axis and/or a valve rod of the control valve. This enables, for example, the realization of a distribution system. A fluid can thus be enabled, for example, to distribute itself evenly in the chamber. The fluid collection chamber can have various shapes and/or cross-sections. For example, the fluid collection chamber may have a substantially angular or substantially round cross-sectional shape, wherein other cross-sectional shapes are also conceivable. The fluid collection chamber may be formed as a substantially annular cavity. For example, the fluid collection chamber can extend in the circumferential direction of the adapter insert at least semicircularly, such as fully circularly, in particular substantially completely around the stroke axis and/or the valve rod of the control valve. It is also conceivable for the fluid collection chamber to be less than a semicircle in the circumferential direction, e.g. various circular segments in the range of approximately 10°-360°.

The fluid collection chamber can be substantially completely enclosed by the insert body, in particular the distance extension section, for example apart from an inlet, e.g. the fluid inlet connection opening and/or an outlet.

The fluid collection chamber may have a base surface for collecting fluid which is substantially uniformly planar and/or flat, in particular free of elevations and/or recesses. “Planar and/or flat” can be understood as substantially flat, for example as an extension of a plane in a substantially horizontal direction, for example transversely to the stroke axis. This can, for example, ensure that a fluid, e.g. water, in particular directly after entering the chamber, can be distributed all around (e.g. around a center axis/stroke axis) e.g. immediately, continuously and/or evenly. The base surface can be formed at or form a deepest region of the fluid collection chamber, e.g. be located at a deepest and/or lowest region in the vertical direction, e.g. viewed in the direction of the stroke axis. This can, for example, ensure that a fluid collects at the base surface where it can be distributed. A size, a dimension and/or a volume of the fluid collection chamber may be variable. For example, a height may be determined substantially in the direction of the stroke axis, e.g. from the base surface to an upper wall. For example, the fluid collection chamber may have a height in the range of approximately 20-60 mm. A width of the fluid collection chamber can, for example, be determined substantially transversely to the stroke axis. In the case of a fluid collection chamber designed as a substantially annular cavity, the width can, for example, be determined as the difference between an outer wall, or an outer diameter, of the fluid collection chamber and an inner wall, or an inner diameter, of the fluid collection chamber. An exemplary outer diameter of the fluid collection chamber can be in the range of approximately 40-250 mm. An exemplary inner diameter of the fluid collection chamber can be in the range of approximately 30-100 mm.

The insert body can comprise at least one fluid passage channel that leads into the fluid collection chamber, in particular directly and/or without interruption. The fluid passage channel at least sectionally may have a bent, inclined and/or curved course. Changes in direction such as curves or the like are also conceivable. The at least one fluid passage channel can, for example, be designed as an outlet for the fluid collection chamber and/or connect to the base surface, e.g. at the deepest point of the fluid collection chamber. The fluid inlet connection opening and the at least one fluid passage channel can lead into the fluid collection chamber and, for example, be designed as an inlet or outlet.

The adapter insert may comprise a, in particular flange-like, fluid collection chamber limiting element. The fluid collection chamber limiting element may be configured to define a dimension, such as a size, a shape and/or a cross-section of the fluid collection chamber, in particular in connection with the insert body, such as with the distance extension section. The fluid collection chamber limiting element can, for example, be made in one piece, for example of metal. In an exemplary embodiment, the fluid collection chamber limiting element has the same material as the insert body and/or the adapter insert. For example, the insert body can form a part, portion and/or section of the fluid collection chamber, e.g. a wall, and the fluid collection chamber limiting element can form another part, portion and/or section, wherein these can then form, shape and/or delimit the fluid collection chamber in combination with each other. In other words, the fluid collection chamber in such an example would be multi-part or two-part. The fluid collection chamber limiting element can be attachable to the insert body and/or the adapter insert in a force-fit and/or form-fit manner, for example by being held in position, in particular by a contact pressure of the housing cover. The fluid collection chamber limiting element can be constructed rotationally symmetrical and be formed substantially flange-like and/or plate-like. As an example, the fluid collection chamber limiting element may have a substantially hollow cylindrical section which adjoins a plate-shaped section, wherein the fluid collection chamber limiting element may have a substantially T-shaped cross section when viewed from the side. The use of a fluid collection chamber limiting element can provide different/diverse sizes, shapes and/or cross-sections of the fluid collection chamber without, for example, having to replace the (entire) insert body; only a different fluid collection chamber limiting element has to be used. In this way, a high degree of modularity is achieved. It is also not necessary to provide different insert bodies for different/diverse sizes, shapes and/or cross-sections of the fluid collection chamber, which increases flexibility.

In a third embodiment of the disclosure, which can be combined with one or more of the aspects and/or embodiments of the disclosure described herein, an adapter insert is provided for a modular control valve of a process plant, such as a chemical plant, a power plant, a food processing plant, or the like, for forming a steam converter.

The adapter insert according to the disclosure can comprise an insert body with a distance extension section for arrangement between a valve housing and a housing cover or between the valve housing and a lantern of the control valve.

The insert body may comprise at least one fluid passage channel extending from a fluid collection chamber to at least one inlet opening of a, in particular substantially sleeve-shaped, flow regulating element, in particular according to one or more of the aspects and/or embodiments of the disclosure described herein, for distribution of fluid, in particular directly and/or without interruption. Several fluid passage channels are also conceivable, which for example are arranged uniformly spaced apart from one another, for example in order to achieve an even better and/or more uniform fluid distribution.

The, in particular substantially sleeve-shaped, flow regulating element can be connected to the insert body, in particular in a material connection, such as welded. The at least one fluid passage channel can extend from a deepest region of the fluid collection chamber, in particular a base surface of the fluid collection chamber for collecting fluid, to the at least one inlet opening. As the fluid collects at the deepest region, it can be reliably and easily led to the appropriate location. This facilitates fluid flow or fluid passage and can even create a self-cleaning effect, for example when a fluid inlet into the chamber is stopped and the remaining fluid drains and/or flows out. A fluid can pass through the fluid passage channel from the fluid collection chamber to the flow regulating element, where it can encounter a vapor located there in order to come into contact with it, for example to cool it.

An orientation, inclination and/or dimension of the at least one fluid passage channel may be matching and/or configured to one or more, in particular substantially sleeve-shaped, flow regulating elements, in particular to an arrangement and/or orientation of the inlet opening formed therein. For example, the at least one fluid passage channel may, for example, be inclined and/or angled with respect to a vertical direction, in particular a direction of the stroke axis. This can enable the fluid to pass from the fluid collection chamber to its intended place of use, wherein, for example, larger radial/horizontal distances can be reached, for example an inlet located at a flow regulating element with a larger diameter. This also allows the fluid, e.g. water, to flow rapidly downwards, e.g. substantially in the direction of the stroke axis. As already embodied, a plurality of fluid passage channels may be used, which may be substantially evenly distributed, e.g. spaced apart, around the center axis or stroke axis. For example, a number of the plurality of fluid passage channels may depend on and/or be selected based on the dimensions, for example a diameter of the insert body, the dimensions of the base surface and/or a circumference.

The insert body can have one or more clamping surfaces for clamping the substantially sleeve-shaped flow regulating element, in particular for clamping between the insert body and a valve seat of the control valve. These can be formed as identically as possible with regard to a distance from the center axis and/or stroke axis in order to provide the greatest possible compatibility for several designs. At least one compensating element, e.g. substantially annular compensating element, can be insertable, deployable, arrangeable and/or clampable on the one or more clamping surfaces. The number of compensating elements to be used can depend on a gap, a tolerance and/or a sealing material. Alternatively, or additionally, forming a sealing edge, for example with a conical shape, can also be provided. The provision of one or more clamping surfaces and/or at least one compensating element can facilitate assembly and/or centering. This can also improve tightness.

In a further embodiment of the disclosure, a flow regulating element is provided for connection to an adapter insert, in particular according to one or more of the aspects and/or embodiments of the disclosure described herein, for a modular control valve of a process plant, such as a chemical plant, a power plant, a food processing plant, or the like, for forming a steam converter.

A “flow regulating element” can be understood as an apparatus, component, device and/or unit which is configured and/or designed to influence, control, regulate and/or adjust a flow, e.g. a fluid flow and/or a flow path of a fluid. A flow regulating element can therefore have both a throttling function, for example to slow down, throttle and/or decelerate a fluid, and a distribution function, for example to direct, lead, guide and/or control a fluid, for example in a specific direction and/or to a specific location. A flow regulating element can therefore also be referred to as a throttling element and/or flow divider. Flow regulating elements described herein are connected or connectable to the insert body and/or the adapter insert, in particular with a material connection, such as welded. The flow regulating element can, for example, be formed in one piece (e.g. with the insert body and/or the adapter insert) and/or in layers and/or produced in one piece, such as by means of a 3D printing process. The flow regulating element can, for example, be produced from metal, wherein this can have the same material as the insert body and/or the adapter insert.

The flow regulating element may have various shapes and/or cross-sections. For example, the flow regulating element may comprise a substantially sleeve-shaped and/or hollow cylindrical body which may be designed for distribution of fluid and may comprise at least one fluid distribution channel. A “fluid distribution channel” may be referred to as a channel which may be configured and/or designed to distribute, direct, guide and/or control a fluid, in particular within the flow regulating element. The substantially sleeve-shaped body can, like the flow regulating element, be produced in one piece and/or in layers, such as by means of a 3D printing process and/or from metal, for example.

The at least one fluid distribution channel can extend at least partially in the axial direction of the substantially sleeve-shaped body, for example in the vertical direction or in the direction of the stroke axis. The at least one fluid distribution channel can extend over almost an entire, in particular axial, height of the substantially sleeve-shaped body. The at least one fluid distribution channel can, for example, extend within the substantially sleeve-shaped body, e.g. be formed therein, such as in its wall, in particular its circumferential wall, and extend, for example in the axial direction, up to the at least one throttle channel. The fluid distribution channel can, for example, be designed as a substantially elongated bore or blind hole (e.g. if the body is in one piece), or as a groove or notch, as described further below (e.g. if the body is in two or more pieces). The at least one fluid distribution channel may lead into the at least one throttle channel and/or be at least connected thereto, in particular fluidically. The at least one throttle channel may extend in the radial direction of the substantially sleeve-shaped body, in particular substantially transversely to the fluid distribution channel, for example transversely to the stroke axis. In an exemplary embodiment, several throttle channels can be provided, which are arranged or spaced apart from one another at equal distances, for example. As an example, the throttle channels can form a kind of grid structure similar to a perforated plate and/or be arranged in this way. A “throttle channel” can be a channel or passage that can be configured and/or designed to control, regulate, throttle, in particular slow down and/or decelerate a fluid, in particular a flow rate and/or a speed. At the throttle channel, steam can come into contact with a fluid, e.g. water, to cool it down, for example fluid entering via the fluid inlet connection opening. The at least one fluid distribution channel can connect several throttle channels with each other, in particular fluidically. For example, the flow regulating element may comprise a plurality of fluid distribution channels extending in the axial direction of the substantially sleeve-shaped body, wherein the fluid distribution channels may be arranged uniformly distributed and/or spaced apart in the circumferential direction of the substantially sleeve-shaped body.

In a further embodiment of the disclosure, there is provided a flow regulating element, in particular according to one or more of the aspects and/or embodiments of the disclosure described herein, for connection with an adapter insert, in particular according to one or more of the aspects and/or embodiments of the disclosure described herein, for a modular control valve of a process plant, such as a chemical plant, a power plant, a food processing plant, or the like, for forming a steam converter. The flow regulating element may have various shapes and/or cross-sections. For example, the flow regulating element may comprise a substantially sleeve-shaped and/or hollow cylindrical body which may be designed for distribution of fluid.

The substantially sleeve-shaped body can comprise at least two sleeves, in particular arranged concentrically to one another, for example at least one inner sleeve and one outer sleeve, in particular surrounding the same. The inner sleeve and/or the outer sleeve can be formed substantially in the shape of a hollow cylinder. In other words, the substantially sleeve-shaped body can be designed in two parts (or also in several parts).

The substantially sleeve-shaped body may comprise at least one fluid distribution channel which extends between the inner sleeve and the outer sleeve, in particular in the axial direction of the substantially sleeve-shaped body. The at least one fluid distribution channel may be formed and/or delimited by the inner sleeve and/or the outer sleeve. The at least one fluid distribution channel can be formed on an outer side (e.g. a circumferential surface or lateral surface) of the inner sleeve and/or an inner side (e.g. an inner surface) of the outer sleeve. At this point, explicit reference should again be made to the combination that at least one fluid distribution channel can also be formed on both, i.e. inner and outer sleeve, which, for example, cooperate with each other. The at least one fluid distribution channel can, for example, be formed as a recess or cutout, such as a groove or notch. For example, the at least one fluid distribution channel may be formed i) as a recess, for example as a substantially elongated groove, on an outer side, for example a circumferential surface, of the inner sleeve, or ii) as a recess, for example as a substantially elongated groove, on an inner side, for example a circumferential surface, of the inner sleeve, or as a combination of i) and ii).

The inner sleeve and/or the outer sleeve can each have one or more throttle channels, which in particular extend in the radial direction of the substantially sleeve-shaped throttle body, in particular substantially transversely to the fluid distribution channel and/or transversely to the stroke axis, and/or in particular each extend substantially completely through the inner sleeve and/or the outer sleeve. The inner sleeve and/or the outer sleeve may have several groups of throttle channels, in particular arranged substantially in a circle. As an example, the throttle channels can form a kind of grid structure similar to a perforated plate and/or be arranged in this way. A group of throttle channels can be arranged offset with respect to a neighboring group of throttle channels, in particular in the circumferential direction of the inner sleeve and/or the outer sleeve. The one, in particular substantially circularly arranged, group of throttle channels and the neighboring, in particular substantially circularly arranged, group of throttle channels may additionally or alternatively be located at different, in particular axial, heights. In an exemplary embodiment, at least one throttle channel of a group of throttle channels, in particular arranged substantially circularly, can be arranged approximately between two throttle channels of an adjacent group of throttle channels, in particular arranged substantially circularly, in particular approximately centrally therebetween. A size, shape and/or cross-section of the throttle channels can be variable, i.e. different or the same.

The inner sleeve and/or the outer sleeve can each have one or more throttle channels, wherein at least one throttle channel of the inner sleeve is arranged offset with respect to at least one throttle channel of the outer sleeve or vice versa, in particular in the axial direction and/or circumferential direction of the substantially sleeve-shaped body. The inner sleeve and the outer sleeve are fixable or are fixed to one another in the axial direction, in particular in a form-fit manner, such as by means of a form-fit element and/or in a force-fit manner, such as by means of a clamping connection.

The adapter insert, the flow regulating element, in particular connected thereto, and, optionally, a connection piece and/or optionally a fluid supply device, in particular a water connection, can be formed in one piece and/or in layers, such as by using a 3D printing process. This facilitates the producing of complex geometries, for example.

As mentioned above, a plurality of elements, apparatus, components, devices and/or units described herein may be formed integrally and/or in layers with each other, such as by means of a 3D printing process. This may concern, for example, the adapter insert, the insert body, the distance extension section, the connection piece, the fluid supply device, the coupling surface(s), the fluid collection chamber, the fluid collection chamber limiting element, the flow regulating element and/or the clamping surfaces. However, it is also conceivable that one or more of these elements, apparatus, components, devices and/or units mentioned or described herein are formed as a separate component. The adapter insert or the insert body can therefore also be formed and/or designed in several parts. These separate components can be plugged into each other and/or connectable to each other. It is also possible to form a guide part of the insert body, e.g. a guide part that points towards and/or guides the control rod, as a separate component.

A flow path of a fluid, in particular of water, can run from the fluid supply device, in particular the water connection, in particular via the optional connection piece, via the fluid inlet connection opening, via the fluid collection chamber and via the fluid passage channel, to the flow regulating element, in particular to the inlet opening, the at least one fluid distribution channel and the at least one throttle channel, where the fluid can come into contact with steam, for example overheated steam, and cool it.

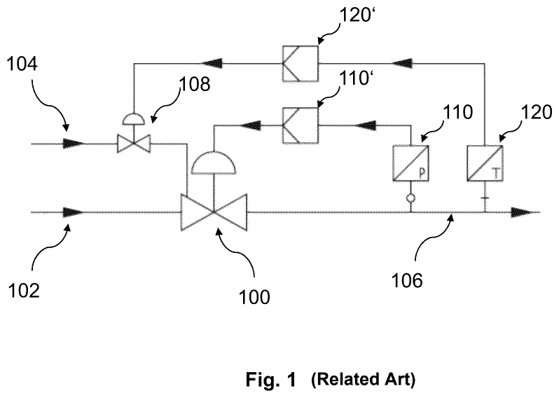

FIG. 1 shows a separate steam converter 100, for example a special control valve 100 or steam converter valve 100 according to the state of the art. FIG. 1 can be used to explain the functional principle of a steam converter, which can also substantially apply to a steam converter described herein, but without providing additional control valves.

For example, a conventional steam converter 100 may comprise a special modified control valve 100 that, for example, combines or brings steam 102, e.g. overheated steam 102, and a fluid 104 in contact with each other to produce a steam flow 106, in particular a steam flow 106 leaving the steam converter, which is deformed, in particular cooled and/or throttled. The fluid can be regulated/controlled, for example, via a connection 108, e.g. a control valve, which is designed, for example, as an inflow valve of the water of the cooling water. As can be seen in FIG. 1, several transducers 110/120, in particular measuring transducers 110/120, can be provided, which can record a parameter, e.g. pressure “P” and/or temperature “T”, in particular of the steam flow 106 and can deform or adapt and/or feed back for a control element 110′/120′, e.g. connected downstream. For example, a pressure can be measured with the measuring transducer 110, which can return the measured pressure value “P” to the steam converter 100 to control the pressure and/or a valve position (e.g. extend/retract). Alternatively, or additionally, a temperature can be measured by the measuring transducer 120, which can return the measured temperature value “T” to the connection 108 for controlling the flow rate and/or the inflow of the fluid. However, embodiments of the disclosure described herein do not rely on such control valves and/or additional complicated circuitry, which reduces complexity.

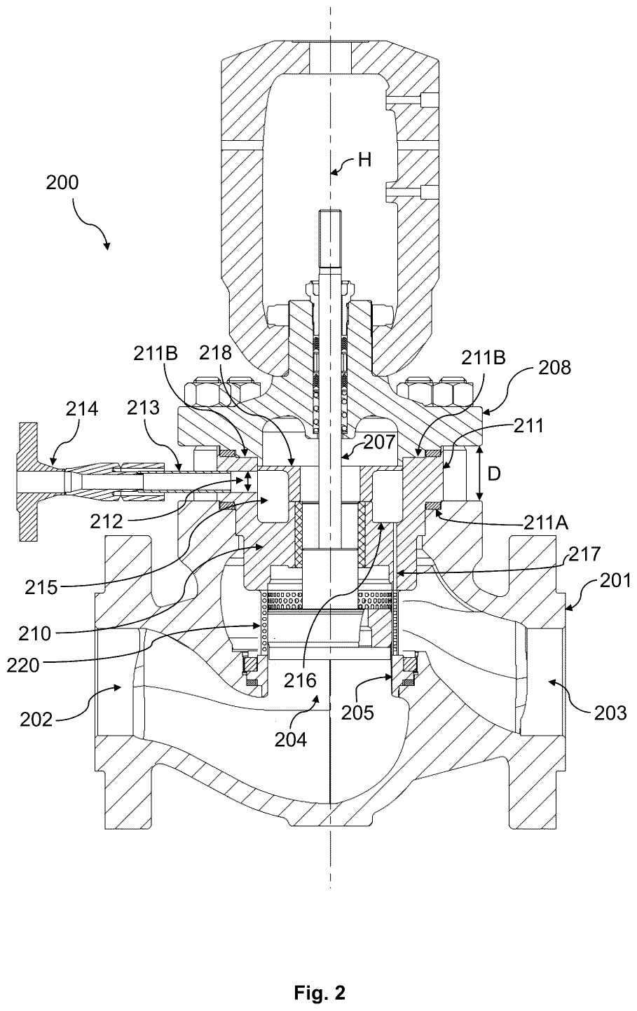

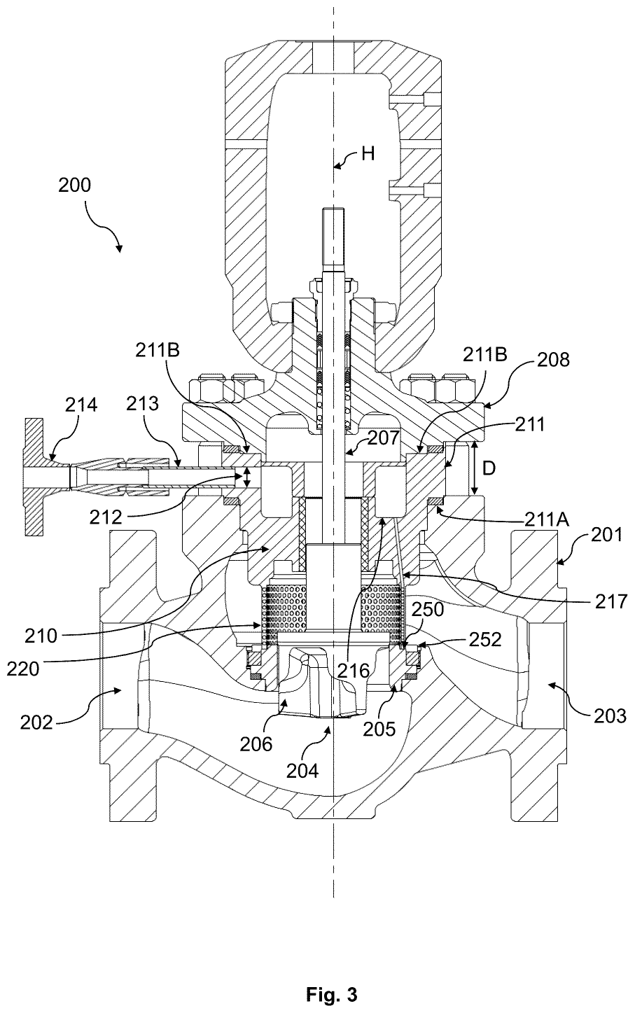

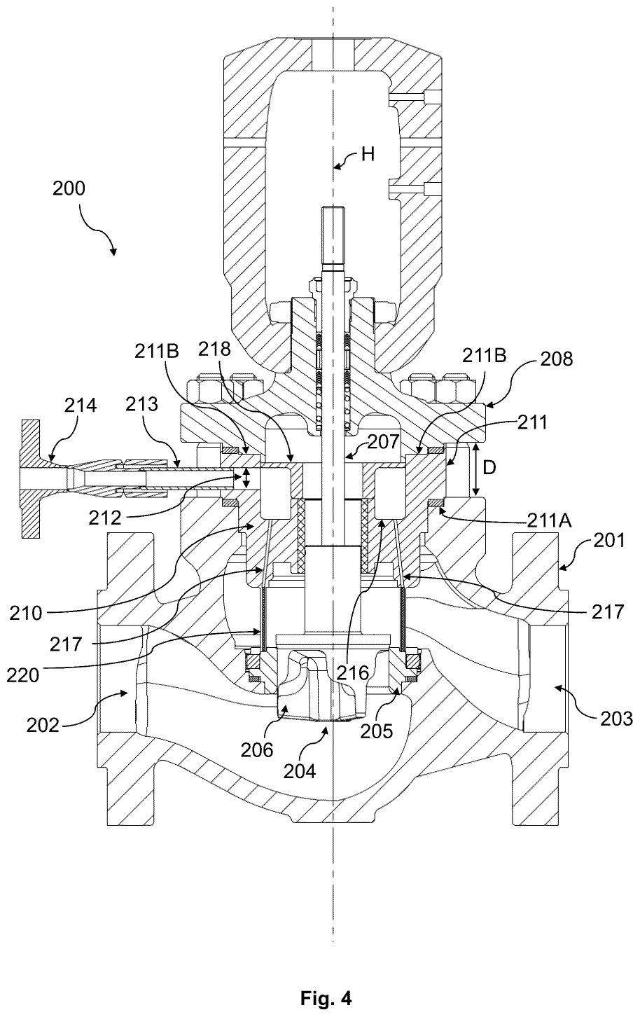

FIGS. 2-5 all show a control valve that is equipped with an adapter insert according to the disclosure and a flow regulating element according to the disclosure. In this context, however, it should be explicitly pointed out that these figures are only designed to illustrate the function(s) and/or structural features of the adapter insert, the flow regulating element and/or their combination. Accordingly, features of the control valve shown are not to be considered essential. It should also be understood that the adapter insert can, in some cases, be produced separately from the flow regulating element. Accordingly, the features of the flow regulating element (or its components) are generally not to be regarded as essential for the adapter insert (or its components). It is also not necessary, for example, to insert, mount and/or use the adapter insert and/or the flow regulating element in a control valve; other applications, as already mentioned above, are also conceivable, for example. It should also be noted that the flow regulating element may be shown/indicated differently in cross-section in these figures (e.g. to illustrate the outer side/surface of the grid structure or the perforated plate), but this should not be understood as limiting. In FIG. 3-4, the control element is designed as a V-port, wherein this is also merely optional.

Thus, the disclosure is not limited to the use of the control valve as a whole, and/or all (sub) components, i.e. adapter insert and flow regulating element. Rather, the various components can be combined in various ways to form one or more embodiments. Further, the number of components, apparatus, and/or (sub) components is not limited to the components shown in FIGS. 2-5. Rather, individual subcomponents can be exchanged or new/other subcomponents can be added.

Based on this, the components of the control valve shown in FIGS. 2-5 will first be discussed together before reference is made to the adapter insert according to the disclosure and/or the flow regulating element according to the disclosure.

FIGS. 2-5 show a control valve 200 comprising an adapter insert 210 according to the disclosure and a flow regulating element 220 according to the disclosure. The control valve 200 may be a modular control valve 200 of a process plant, such as a chemical plant, a power plant, a food processing plant, or the like. The control valve 200 may include a valve housing 201 having an inlet opening 202 and an outlet opening 203, and a passage opening arranged therebetween. The valve housing 201 may further comprise a valve seat 205 surrounding the passage opening 204. The valve seat 205 may be fully circular. The valve housing 201 further comprises a movable control element 206 (see FIGS. 3-4), which is attached to a control rod 207. The valve seat 205 and the control element 207 can be matched to one another for sealing engagement. The actuator 207 may be translationally movable along a stroke axis H (e.g. substantially vertical direction H) and comprise a stroke valve element, for example a valve piston or valve plug. The control element 207 may be configured to adjust a process fluid flow of a process plant (not shown).

The control valve 200 can comprise a housing cover 208 arranged opposite the passage opening 204 with a through-opening 209 and optionally, a coupling structure (not shown), in particular a lantern, between the valve housing 201 and the housing cover 208.

The adapter insert 210 according to the disclosure can comprise an insert body (can also substantially correspond to reference sign 210) with a distance extension section 211 for arrangement between the valve housing 201 and a housing cover 208 or between the valve housing 201 and a lantern of the control valve (not shown). The adapter insert 210 and/or the insert body 210 are formed in one piece, for example, from metal.

The insert body 210 and/or the adapter insert 210 can be formed and/or constructed substantially rotationally symmetrical, for example substantially annular, sleeve-shaped and/or substantially (hollow) cylindrical. This rotationally symmetrical shape makes it possible, for example, to align or adjust, such as rotate, the insert body 210 or the adapter insert 210 in the circumferential direction, for example after insertion or insertion into the valve housing 201. In other words, the insert body 210 or the adapter insert 210 can, for example, be designed to be rotatable, in particular in the circumferential direction (e.g. by 360° or more/less), such as in an inserted state in the valve housing. The same applies to the lantern (not shown and/or the housing cover 208, for example when the insert body 210 or the adapter insert 210 is inserted therein). For example, a fluid inlet connection opening 212, a connection piece 213 and/or a fluid supply device 214, for example a water connection, described herein and arranged/designed therein can be aligned, rotated and/or adjusted in a simple manner, for example during and/or also after assembly. This makes it possible, for example in the circumferential direction, to provide several different settings, positions and/or orientations, which, among other things, increases flexibility and saves time during assembly. As a result, the position of a water connection 214, for example, can be freely selectable, in particular in the circumferential direction, and can be configured accordingly as required.

As can be seen in FIGS. 2-5, the distance extension section 211 may, for example, have a flange-like and/or plate-like configuration and/or be adjacent to or connected to the insert body 210. For example, the distance extension section 211 may, in particular in an inserted state, increase, widen, raise and/or lengthen the spacing D between the valve body 201 and the housing cover 208 or between the valve body 201 and the lantern (not shown) of the control valve 200.

The distance extension section 211 may have a coupling surface 211A, which is formed complementary in shape to the valve housing 201, and another coupling surface 211B, in particular opposite thereto, which is formed complementary in shape to the housing cover 208 or the lantern (not shown). The two coupling surfaces 211A/211B can be substantially opposite each other in the direction of the stroke axis H, for example in the vertical direction. Optional sealing elements (e.g. one or more) (see hatched elements on sealing surfaces 211A and 211B) can be used on the coupling surfaces. For example, at least one sealing means, in particular a ring seal, may be present or inserted between the coupling surface 211A of the distance extension section 211 and the valve housing 201 and/or at least one sealing means, in particular a ring seal, may be present or inserted between the other coupling surface 211B of the distance extension section 211 and the housing cover 208 or the lantern (not shown). As can be seen in FIGS. 2-5, a fluid inlet connection opening 212 is located between the two coupling surfaces 211A/211B, in particular at least sectionally and/or at least partially.

The distance extension section 211 can be configured, formed and/or dimensioned, in particular in the assembled state of the adapter insert 210, to form a spacing D, in particular an interspace D, between the valve housing 201 and the housing cover 208 or the valve housing 201 and the lantern (not shown) in a range of at least approximately 2 cm, at least 1.5 cm or at least 1 cm, wherein a thickness D or height D of the distance extension section 211, in particular in the direction of the stroke axis H, can correspond, for example, at least approximately 2 times a diameter of the connection tube or the connection piece. The connecting tube can be provided substantially in the center of the distance extension section 211. A minimum thickness D or height D of the distance extension section 211 can thus be provided above or below (in particular in the direction of the stroke axis) the connecting tube. For example, the following relation can be used for this (height D-diameter of connecting tube)/2. For example, a distance in the direction of the stroke axis H can be provided in the range of at least approximately 5 mm above and below the connecting tube.

The fluid inlet connection opening 212 may be formed as a channel, such as a through channel or inlet channel for the fluid, for example water (not shown). As shown, the fluid inlet connection opening 212 may be connectable, such as detachably, to a connection piece 213, which in turn may be connected, in particular directly, detachably and/or leak-free, to a fluid reservoir, a fluid source, for example a water source (not shown), and a fluid supply device 214, in particular a water connection 214.

As can be seen in FIGS. 2-5, the fluid supply device 214, in particular the water connection, and/or the connection piece 213, can extend between the valve housing 201 and the housing cover 208, in particular substantially transversely to a stroke axis of the control valve 200, in particular in the assembled state. The fluid supply device 214, in particular the water connection, and/or the connection piece 213 can be rotatable and/or alignable during an assembly, in particular by the adapter insert 210, in particular in the circumferential direction, in particular by 360°, for example (e.g. by 360° or more/less). For example, the fluid supply device 214, in particular the water connection, and/or the connection piece 213, can be easily aligned, rotated and/or adjusted, for example during and/or after assembly. This enables several different positions, for example in the circumferential direction, which, among other things, increases flexibility and saves time during assembly. As a result, the position of a water connection 214, for example, can be freely selectable and/or changeable/adaptable. It is also conceivable to merely loosen the attachment between the housing cover 208 and the valve housing 201 (or also the lantern, if this is used) in order to rotate the adapter insert 210 and/or align the fluid supply device 214, in particular the water connection, and/or the connection piece 213.

FIGS. 2-5 may show an assembled state in which the fluid inlet connection opening 212 is located at least sectionally between the valve housing 201 and the housing cover 208. In the assembled state of the adapter insert 210, the fluid inlet connection opening 212 can be located, in particular in the vertical direction, for example as mentioned above in the direction of the stroke axis H, at least sectionally or substantially completely between the valve housing 2018 and the housing cover 208. It should be understood that this may also be between the valve housing 201 and the lantern (not shown) of the control valve, if used.

As can be seen, a diameter of the fluid inlet connection opening 212 may be formed to be smaller than the spacing D, in particular the interspace D, which is defined and/or formed, in particular by the distance extension section 211, between the valve housing 201 and the housing cover 208. In this way, the fluid inlet connection opening 212 can be arranged substantially completely therebetween.

The fluid inlet connection opening 212 can extend through the adapter insert 210, in particular the insert body and/or the distance extension section, for example completely through or at least partially, for example at least partially extending in a radial or horizontal direction of the adapter insert, in particular substantially transversely to a stroke axis H of the control valve 200. As can be seen, the fluid inlet connection opening 212 can extend substantially completely or completely through the insert body 210, in particular the distance extension section 211. For example, the fluid inlet connection opening 212 can in this way create and/or provide a fluid connection to an interior, an inner space or an inner region of the control valve 200, for example the valve housing 201.

The fluid inlet connection opening 212 may be alignable by rotating the adapter insert 210 and/or the insert body 210, in particular during or after assembly, in particular circumferentially, in particular by 360° (or more/less). For example, a fluid inlet connection opening 212 described herein and arranged/formed therein can be easily aligned, rotated and/or adjusted, for example during and/or after assembly. This enables, for example in the circumferential direction, several different positions which, among other things, increases flexibility and saves time during assembly. In this sense, the fluid inlet connection opening 212, the adapter insert and/or the insert body can thus be configured and/or designed to be rotatable, pivotable, alignable and/or adjustable. As a result, the position of a water connection, for example, can be freely selectable.

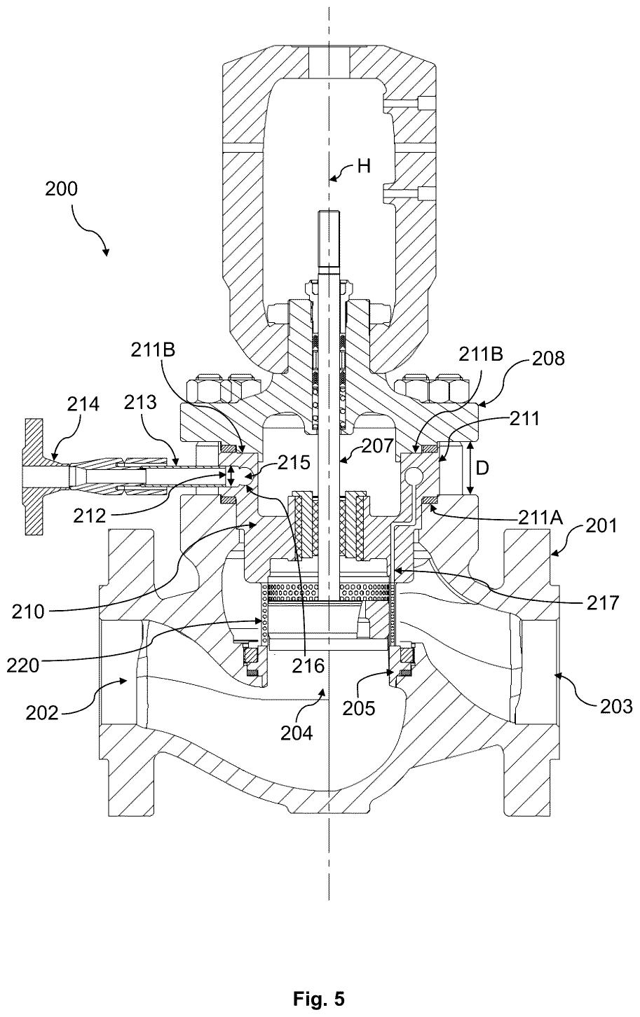

As can be seen in FIGS. 2-5, the insert body 210 can form a fluid collection chamber 215 which, in the assembled state of the adapter insert 210, extends at least sectionally between the valve housing 201 and the housing cover 208. The insert body 210 or the adapter insert 210 can at least partially form the fluid collection chamber 215, for example a chamber that is not necessarily completely enclosed by the insert body 210. It is also possible that the fluid collection chamber 215 is partially formed by/in the distance extension section 211. It is also conceivable that the fluid collection chamber 215 has a multi-part structure, for example partially formed by the insert body 210 and/or the distance extension section 210 and in conjunction with another or further element, part and/or another or further structure 218 forms or shapes the fluid collection chamber 215 (see, for example, FIGS. 3-4). However, the insert body 210 and/or the adapter insert 210 and/or the distance extension section 211 may also substantially completely enclose the chamber 215 (see, for example, FIG. 5).

The fluid collection chamber 215 may comprise an inlet, for example the fluid inlet connection opening 212 described herein, wherein the fluid inlet connection opening 212 may, for example, lead into the fluid collection chamber 215, in particular directly and/or without interruption. The fluid collection chamber 215 may extend in the circumferential direction of the adapter insert 210 (and/or the insert body 210) (i.e. may also be substantially rotationally symmetrical), in particular around a stroke axis H and/or a valve rod 207 of the control valve 200. The fluid collection chamber 215 may have various shapes and/or cross-sections. For example, as can be seen in FIGS. 2-4, the fluid collection chamber 215 can have a substantially angular cross-sectional shape or, as can be seen in FIG. 5, a substantially round cross-sectional shape. The fluid collection chamber 215 may be formed as a substantially annular cavity. For example, the fluid collection chamber can extend in the circumferential direction of the adapter insert at least semicircularly, such as fully circularly, in particular substantially completely around the stroke axis H and/or the valve rod 207 of the control valve.

The fluid collection chamber 215 may have a base surface 216 for collecting fluid that is substantially uniformly planar and/or flat, in particular free of elevations and/or recesses. This can, for example, ensure that a fluid, e.g. water, in particular directly after entering the chamber 215, can be distributed all around (e.g. around a center axis/stroke axis H and/or the valve rod 207) e.g. immediately, continuously and/or evenly. The base surface 216 may be formed at or forming a deepest region of the fluid collection chamber 215, for example located at a deepest and/or lowest region in the vertical direction, for example as viewed in the direction of the stroke axis H.

The insert body 210 may comprise at least one fluid passage channel 217 that leads into the fluid collection chamber 215, in particular directly and/or without interruption. As can be seen in FIGS. 2-3 and 5, a single fluid passage channel 217 may be provided. However, as shown in FIG. 4, two fluid passage channels 217, or even more than two, may also be provided. In this way, for example, an even better distribution of fluid can be achieved. As can be seen in FIG. 5, the fluid passage channel 217 can at least sectionally have a bent, inclined and/or curved course. Changes in direction such as curves or the like are also conceivable. The at least one fluid passage channel 217 can, for example, be designed as an outlet for the fluid collection chamber 215 and/or connect to the base surface 216, for example at the deepest point of the fluid collection chamber 215.

As can be seen in FIGS. 2-4, a, in particular flange-like, fluid collection chamber limiting element 218 can be provided that can form a fluid collection chamber 215, for example in conjunction with the insert body 210 and/or the adapter insert 210.

For example, the insert body 210 may form one part, portion and/or section of the fluid collection chamber 215, such as a wall, and the fluid collection chamber limiting element 218 may form another part, portion and/or section, wherein these may then form, shape and/or delimit the fluid collection chamber 215 in combination with each other. In other words, the fluid collection chamber in FIGS. 2-4 would be multi-part or two-part. The use of a fluid collection chamber limiting element 218 can provide different/different sizes, shapes and/or cross-sections of the fluid collection chamber 215 without, for example, having to replace the (entire) insert body 210 for this purpose; only a different fluid collection chamber limiting element 218 has to be used. In this way, a high degree of modularity is achieved. It is also not necessary to provide different insert bodies 210 for different/different sizes, shapes and/or cross-sections of the fluid collection chamber 215, which increases flexibility.

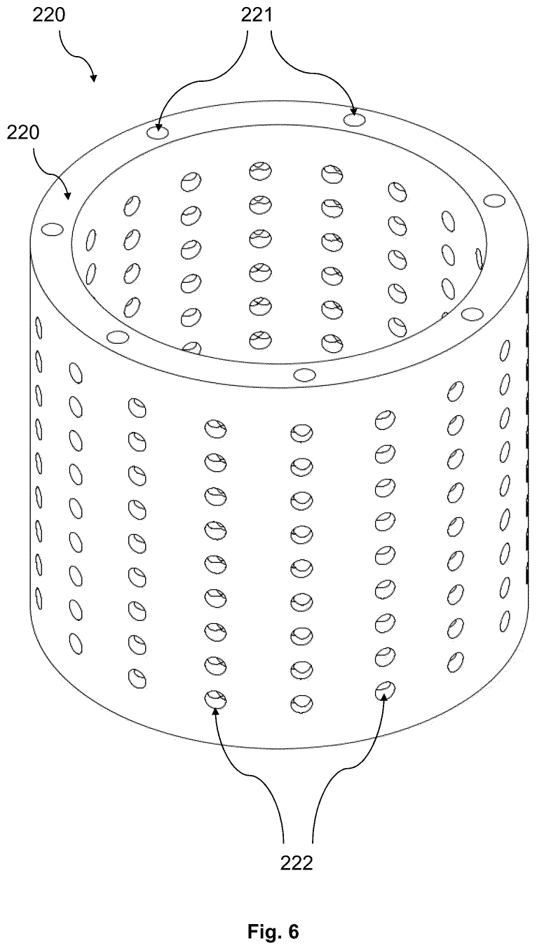

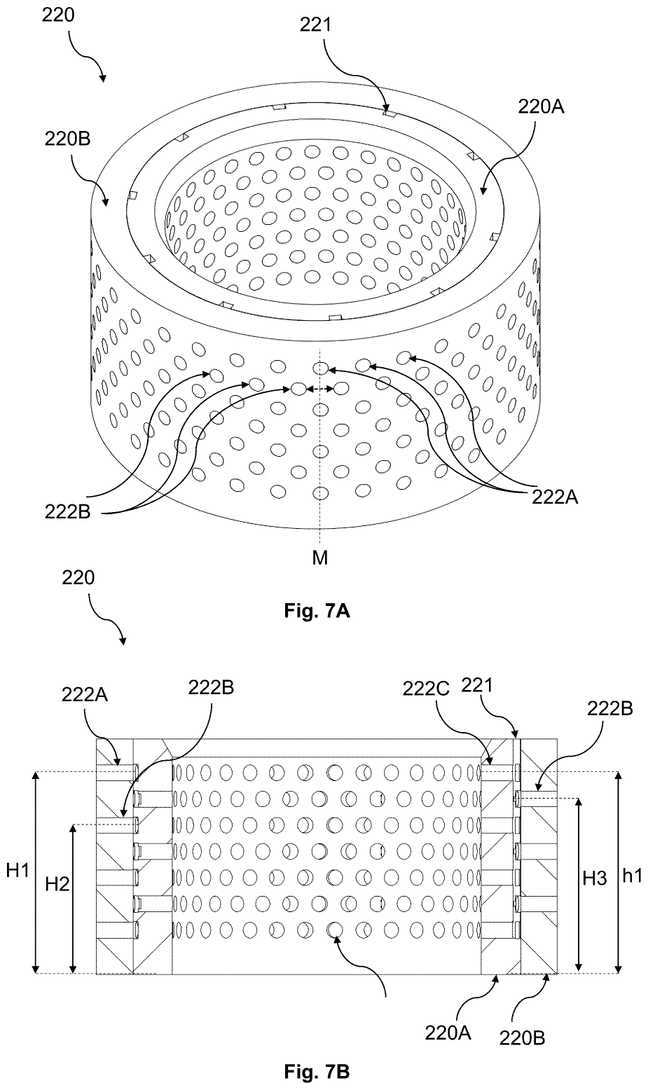

A flow path of a fluid, in particular of water, can run from the fluid supply device 214, in particular the water connection 214, in particular via the optional connection piece 213, via the fluid inlet connection opening 212, via the fluid collection chamber 215 and via the fluid passage channel 217, to the flow regulating element 220 (s. FIGS. 6-7B), in particular to the inlet opening 221, the at least one fluid distribution channel 221 and the at least one throttle channel 222, where the fluid can, for example, come into contact with steam, e.g. overheated steam, and cool it.

The at least one fluid passage channel 217 may extend from the fluid collection chamber 217 to at least one inlet opening 221 of a, in particular substantially sleeve-shaped, flow regulating element 220 in particular according to one or more of the aspects and/or embodiments of the disclosure described herein, for distribution of fluid, in particular directly and/or without interruption. A plurality of fluid passage channels 217 are also conceivable, for example arranged evenly spaced apart from one another, for example to achieve an even better and/or more even fluid distribution.

As indicated in FIG. 3, for example, the insert body can have one or more clamping surfaces 250 for clamping the substantially sleeve-shaped flow regulating element, in particular for clamping between the insert body and a valve seat 205 of the control valve. With regard to a distance from the center axis and/or stroke axis H, these can each be formed as identically as possible in order to provide the greatest possible compatibility for several designs. At least one compensating element 252, e.g. substantially annular compensating element, can be insertable, deployable, arrangeable and/or clampable on the one or more clamping surfaces 250. The number of compensating elements 252 to be used may depend on a gap, a tolerance and/or a sealing material. Alternatively, or additionally, a formation of a sealing edge, for example with a conical shape, may also be provided. The provision of one or more clamping surfaces 250 and/or of at least one compensating element 252 may facilitate assembly and/or centering. In addition, this can improve tightness. These embodiments may apply analogously to the other FIGS. 2 and 4-5.

The flow regulating element 220 is shown in FIGS. 2-5, but is described in more detail below with reference to FIGS. 6 and 7A-B.

The flow regulating elements 220 described in FIGS. 6-7B may be connected to the insert body 210 and/or the adapter insert 210, in particular by material connection, such as by welding.

As can be seen in FIGS. 6-7B, the flow regulating element 220 may comprise a substantially sleeve-shaped and/or hollow cylindrical body 220, which may be designed for distribution of fluid and may comprise at least one fluid distribution channel 221.

The at least one fluid distribution channel 221 may extend at least partially in an axial direction of the substantially sleeve-shaped body 220, for example in a vertical direction or in the direction of the stroke axis H (see FIGS. 2-5). The at least one fluid distribution channel 221 can extend over almost an entire, in particular axial, height of the substantially sleeve-shaped body 220. The at least one fluid distribution channel may, for example, extend within the substantially sleeve-shaped body 220, e.g. be formed therein, such as in its wall, in particular its circumferential wall, and extend, for example in the axial direction, up to the at least one throttle channel 222.

As can be seen, for example, in FIG. 6, the fluid distribution channel can be designed, for example, as a substantially elongated bore or blind hole (e.g. if the body is in one piece). In FIGS. 7A-B it can be seen that the fluid distribution channel can be formed, for example, as a groove or notch (e.g. if the body is in two or more parts).

The at least one fluid distribution channel 221 may lead into the at least one throttle channel 222 and/or be at least connected thereto, in particular fluidically. The at least one throttle channel 222 may extend in the radial direction of the substantially sleeve-shaped body 220, in particular substantially transversely to the fluid distribution channel 221, for example transversely to the stroke axis H (see FIGS. 2-5). In an exemplary embodiment, a plurality of throttle channels 222 can be provided, which are arranged or spaced apart from each other, for example, at equal distances. As an example, the throttle channels 222 may form a kind of grid structure similar to a perforated plate as shown in FIGS. 6-7B and/or be arranged in this manner. The at least one fluid distribution channel 221 may connect several throttle channels 222, in particular fluidically, as shown in detail, for example, in FIG. 7B. The flow regulating element 220 may comprise, for example, a plurality of fluid distribution channels 221 (see, for example, FIG. 6 or also 7A), which extend in the axial direction of the substantially sleeve-shaped body, wherein the fluid distribution channels 221 may be arranged uniformly distributed and/or spaced apart in the circumferential direction of the substantially sleeve-shaped body, for example in a wall or circumferential wall.

As can be seen in FIGS. 7A and 7B, the substantially sleeve-shaped body 220 can comprise at least two sleeves 220A/220B, in particular arranged concentrically to one another, for example at least one inner sleeve 220A and one outer sleeve 220B, in particular surrounding the same. The inner sleeve 220A/220B and/or the outer sleeve 220A/220B may be formed substantially in the shape of a hollow cylinder. In other words, the substantially sleeve-shaped body 220 of FIGS. 7A-B may be designed in two parts (or also in several parts).

The substantially sleeve-shaped body 220 of FIGS. 7A-B may comprise at least one fluid distribution channel 221 extending between the inner sleeve 220A and the outer sleeve 220B, in particular in the axial direction of the substantially sleeve-shaped body 220 (e.g. in the direction of the stroke axis H, see FIGS. 2-5). The at least one fluid distribution channel 221 may be formed and/or delimited by the inner sleeve 220A and/or the outer sleeve 220B. As can be seen in FIG. 7A, the at least one fluid distribution channel 221 may be formed on the outer side (e.g., a circumferential surface or lateral surface) of the inner sleeve 220A. Alternatively or additionally, the at least one fluid distribution channel 221 may also be formed on an inner side (e.g., an inner surface) of the outer sleeve 200B. In contrast to FIG. 6, the at least one fluid distribution channel may be formed, for example, as a recess or cutout, such as a groove or notch. The flow regulating element 220 in the embodiment example of FIG. 6 may be formed in one piece and/or in layers and/or produced in one piece, such as by means of a 3D printing process. Such a geometry is difficult to produce using conventional production methods. 3D printing therefore makes it possible, for example, to produce such complex geometries easily and cost-effectively. In contrast, the channels in the embodiments shown in FIG. 7A and B can be produced by simple machining processes and the subsequent joining of the two sleeves. For example, the axial channels or inner channels can be introduced into the individual sleeves by milling or the like.

The inner sleeve 220A and/or the outer sleeve 220B may each have one or more throttle channels 222. As can be seen in FIG. 7B, the throttle channels 222 can in particular extend in the radial direction of the substantially sleeve-shaped throttle body 220, in particular substantially transversely to the fluid distribution channel 221 and/or transversely to the stroke axis H, and/or in particular extend in each case substantially completely through the inner sleeve 220A and/or the outer sleeve 220B.

The inner sleeve 220A and/or the outer sleeve 220B may comprise several groups of throttle channels 222, in particular arranged substantially circularly, as can be seen in FIGS. 7A-B. As an example, the throttle channels 222 may form a kind of grid structure similar to a perforated plate and/or may be arranged in such a way, for example with throttle channels or groups of throttle channels that may be arranged offset with respect to each other with respect to a circumferential direction and/or an axial height of the sleeves 220A/220B.

In FIG. 7A, for example, one throttle channel 222A is indicated. At the same axial height, for example the height H1 (see FIG. 7B), there may be further throttle channels 222A, which are distributed in the circumferential direction, arranged around the substantially sleeve-shaped body 220, in particular the outer sleeve 222A. These throttle channels 222A may form a group of throttle channels 222A, for example a first group. Furthermore, in FIG. 7A a throttle channel 222B is characterized which is located at a different axial height H2 (or H3), which is different, for example smaller, than H1 (see FIG. 7B), for example thus adjacent. At the same axial height H2 (see FIG. 7B), further throttle channels 222B may be located, which are distributed in the circumferential direction, around the substantially sleeve-shaped body 220, in particular the outer sleeve 220A. These throttle channels 222B may form a group of throttle channels 222B, for example a second group. As can be seen in FIG. 7B, corresponding throttle channels and/or corresponding groups of throttle channels may be equally provided on the inner sleeve 220A, the description of which is not repeated herein for ease of reading and/or applies equally or mutatis mutandis.

The first group of throttle channels (see 222A) may be arranged offset with respect to a neighboring group of throttle channels (see 222B), e.g. arranged at a different, e.g. lower, height H2, in particular in the circumferential direction of the inner sleeve 220A and/or the outer sleeve 220B. As can be seen in FIG. 7A, at least one throttle channel, see e.g. 222A, e.g. of the first group of throttle channels 222A, can be arranged, in particular in the circumferential direction, approximately between two throttle channels (see 222B) of an adjacent, in particular substantially circularly arranged, e.g. at a different, e.g., lower height H2, group of throttle channels 222B, in particular approximately centrally (see line M) therebetween. This is indicated by the double arrow and the dashed line M in FIG. 7A.

As can be further seen in FIG. 7B, the inner sleeve 220A and/or the outer sleeve 220B can each have one or more throttle channels 222 (see 222A, 222B, 222C). The throttle channels 222C or groups of throttle channels 222C of the inner sleeve 220A can be arranged in the same way as the throttle channels 222A/B of the outer sleeve 220B just described, for example offset in such a way, e.g. as described above, that at least one throttle channel of a first group of throttle channels, in particular in the circumferential direction, is arranged approximately between two throttle channels of an adjacent group of throttle channels, in particular arranged substantially circularly, e.g. arranged at a different, e.g. lower, height, in particular approximately centrally between them.

As can be further seen in FIG. 7B, at least one throttle channel 222C of the inner sleeve 220A may be arranged offset with respect to at least one throttle channel 222B of the outer sleeve 220B or vice versa, in particular in the axial direction and/or circumferential direction of the substantially sleeve-shaped body 220. For example, the at least one throttle channel 222C of the inner sleeve 220A may be located at a greater axial height h1 than the throttle channel 222B of the outer sleeve 220B, which is located, for example, at height H2 or H3. Other heights, e.g. smaller or lower, of the throttle channels of the inner sleeve 220A are recognizable and/or removable in FIG. 7B. Due to the, circumferentially displaced arrangement of the throttle channels, it is possible, as shown in FIG. 7B, that the at least one throttle channel 222C of the inner sleeve 220A, which is located at height h1, is located substantially at the same height H1, i.e. h1 is substantially equal to H1, of the at least one throttle channel 222A of the outer sleeve 220B. The throttle channels 222A, 222B and 222B can lead into a, in particular common, throttle channel 221 and be connected thereto, in particular fluidically.

The features disclosed in the preceding description, the figures and the claims may be of importance both individually and in any combination for the realization of the disclosure in the various embodiments.

To enable those skilled in the art to better understand the solution of the present disclosure, the technical solution in the embodiments of the present disclosure is described clearly and completely below in conjunction with the drawings in the embodiments of the present disclosure. Obviously, the embodiments described are only some, not all, of the embodiments of the present disclosure. All other embodiments obtained by those skilled in the art on the basis of the embodiments in the present disclosure without any creative effort should fall within the scope of protection of the present disclosure.

It should be noted that the terms “first”, “second”, etc. in the description, claims and abovementioned drawings of the present disclosure are used to distinguish between similar objects, but not necessarily used to describe a specific order or sequence. It should be understood that data used in this way can be interchanged as appropriate so that the embodiments of the present disclosure described here can be implemented in an order other than those shown or described here. In addition, the terms “comprise” and “have” and any variants thereof are intended to cover non-exclusive inclusion. For example, a process, method, system, product or equipment comprising a series of steps or modules or units is not necessarily limited to those steps or modules or units which are clearly listed, but may comprise other steps or modules or units which are not clearly listed or are intrinsic to such processes, methods, products or equipment.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

### REFERENCE LIST

100 Steam converter
102 Steam
104 Fluid
106 Steam flow
108 Connection
110/120 Transducer
110′/120′ Control element
200 Control valve
201 Valve body
202 Inlet opening
203 Outlet opening
204 Passage opening
205 Valve seat
206 Control elements
207 Control rod
208 Housing cover
209 Through-opening
210 Adapter insert/insert body
211 Distance extension section
211A/B Coupling surface
212 Fluid inlet connection opening
213 Connection piece
214 Fluid supply device
215 Fluid collection chamber
216 Base surface
217 Fluid passage channel
218 Fluid collection chamber limiting element
220 Flow regulating element
220A Inner sleeve
220B Outer sleeve
221 Fluid distribution channels
222 Throttle channel
222A-C Throttle channels
250 Clamping surfaces
252 Compensating element
H Stroke axis
H1, H2, H3 Height
h1 Height
D Spacing, thickness, height
M Line

1. An adapter insert for a control valve of a process plant for forming a steam converter, the adapter insert comprising:
an insert body with a distance extension section configured to be arranged between a valve housing and a housing cover or between the valve housing and a lantern of the control valve, wherein:
the distance extension section comprises a fluid inlet connection opening, which, in an assembled state of the adapter insert, is located at least sectionally between the valve housing and the housing cover or between the valve housing and the lantern of the control valve; and
the insert body forms a fluid collection chamber which, in the assembled state of the adapter insert, extends at least sectionally between the valve housing and the housing cover or the valve housing and the lantern of the control valve.

2. The adapter insert according to claim 1, wherein the fluid inlet connection opening extends completely through the distance extension section, the fluid inlet connection opening leading into a fluid collection chamber.

3. The adapter insert according to claim 1, wherein the distance extension section has a coupling surface which is formed complementary in shape to the valve housing and another coupling surface, which is formed complementary in shape to the housing cover or the lantern, wherein the fluid inlet connection opening is located between the coupling surfaces.

4. The adapter insert according to claim 1, wherein the distance extension section is configured to create a spacing between the valve housing and the housing cover or the valve housing and the lantern, the spacing being matched to a size of a connection piece and/or a fluid supply device.

5. The adapter insert according to claim 1, wherein the fluid inlet connection opening is alignable by rotating the adapter insert and/or the insert body during assembly.

6. The adapter insert according to claim 1, wherein the distance extension section is configured and/or dimensioned, in the assembled state of the adapter insert, to form a spacing between the valve housing and the housing cover or the valve housing and the lantern in a range of at least approximately 2 times a diameter of the connection piece.

7. The adapter insert according to claim 1, wherein the fluid collection chamber extends in the circumferential direction of the adapter insert around a stroke axis and/or a valve rod of the control valve.

8. The adapter insert according to claim 1, wherein the fluid collection chamber is formed as a annular cavity.

9. The adapter insert according to claim 1, wherein the fluid collection chamber is completely enclosed by the insert body.

10. The adapter insert according to claim 1, wherein the fluid collecting chamber has a base surface for collecting fluid which is uniformly planar and/or flat, the base surface being formed at a deepest region of the fluid collecting chamber.

11. The adapter insert according to claim 1, wherein the insert body comprises at least one fluid passage channel which leads into the fluid collection chamber, the fluid passage channel at least sectionally having a bent, inclined, and/or curved course.

12. The adapter insert according to claim 1, further comprising: a fluid collection chamber limiting element configured to define a dimension, a shape, and/or a cross-section of the fluid collection chamber.

13. The adapter insert according to claim 1, wherein the fluid collection chamber is integrally formed with the insert body by three-dimensional printing.

14. The adapter insert for a control valve of a process plant for forming a steam converter, the adapter insert comprising:
an insert body comprising:
a distance extension section configured to be arranged between a valve housing and a housing cover or between the valve housing and a lantern of the control valve,
at least one fluid passage channel which extends from a fluid collecting chamber to at least one inlet opening of a flow regulating element configured to distribute fluid.

15. The adapter insert according to claim 14, wherein the flow regulating element is connected to the insert body, the at least one fluid passage channel extending from a deepest region of the fluid collecting chamber to the at least one inlet opening.

16. The adapter insert according to claim 15, wherein the insert body has one or more clamping surfaces configured to clamp the flow regulating element between the insert body and a valve seat of the control valve.

17. The adapter insert according to claim 14, wherein the adapter insert is formed in one piece and/or in layers, and/or is produced in one piece, the adapter insert and/or the insert body being rotationally symmetrical.

18. A flow regulating element for connection with an adapter insert for a control valve of a process plant for forming a steam converter, the flow regulating element comprising:
a sleeve-shaped body configured to distribute fluid with at least one fluid distribution channel, wherein the at least one fluid distribution channel extends at least partially in an axial direction of the sleeve-shaped body and leads into at least one throttle channel, and wherein the sleeve-shaped body comprises at least two sleeves with at least one inner sleeve and an outer sleeve surrounding the at least one inner sleeve.

19. The flow-regulating element according to claim 18, wherein the fluid distribution channel fluidically connects several throttle channels with one another.

20. The flow regulating element according to claim 18, further comprising: a plurality of fluid distribution channels extending in an axial direction of the sleeve-shaped body, the plurality of fluid distribution channels being uniformly distributed and/or spaced apart in a circumferential direction of the sleeve-shaped body.

21. The flow regulating element according to claim 18, wherein the at least one fluid distribution channel extends between the inner sleeve and the outer sleeve, the at least one fluid distribution channel being formed and/or delimited by the at least one inner sleeve and/or the at least one outer sleeve.

22. The flow regulating element according to claim 18, wherein the at least one fluid distribution channel is formed on the outside of the at least one inner sleeve and/or on the inner side of the at least one outer sleeve, the at least one fluid distribution channel being formed as a recess or cutout.

23. The flow-regulating element according to claim 18, wherein the at least one inner sleeve and/or the at least one outer sleeve each have one or more throttle channels, wherein at least one throttle channel of the at least one inner sleeve is arranged offset with respect to at least one throttle channel of the at least one outer sleeve or vice versa.

24. The flow-regulating element according to claim 18, wherein the at least one inner sleeve and the at least one outer sleeve are fixable or are fixed to one another in the axial direction.

25. A steam converter for a control valve of a process plant, the steam converter comprising:
an adapter insert according to claim 1; and
a flow regulating element connected thereto, the flow regulating element comprising a sleeve-shaped body configured to distribute fluid with at least one fluid distribution channel, wherein the at least one fluid distribution channel extends at least partially in an axial direction of the sleeve-shaped body and leads into at least one throttle channel, and wherein the sleeve-shaped body comprises at least two sleeves with at least one inner sleeve and an outer sleeve surrounding the at least one inner sleeve.

26. The steam converter according to claim 25, wherein the adapter insert and the flow regulating element are formed in one piece and/or in layers.

27. A control valve of a process plant, comprising:
a valve housing with an inlet opening and an outlet opening, and a passage opening arranged therebetween; and
a housing cover with a through-opening arranged opposite the passage opening, wherein the control valve further comprises:
an adapter insert according to claim 1;
a flow regulating element comprising a sleeve-shaped body configured to distribute fluid with at least one fluid distribution channel, wherein the at least one fluid distribution channel extends at least partially in an axial direction of the sleeve-shaped body and leads into at least one throttle channel, and wherein the sleeve-shaped body comprises at least two sleeves with at least one inner sleeve and an outer sleeve surrounding the at least one inner sleeve; and/or
a steam converter comprising the adapter insert and the flow regulating element connected to the adapter insert.

28. The control valve according to claim 27, wherein a fluid supply device and/or a connection piece extends between the valve housing and the housing cover or the valve housing and the lantern of the control valve, wherein the fluid supply device and/or the connection piece are rotatable and/or alignable during assembly by the adapter insert.

29. The control valve according to claim 27, wherein the fluid inlet connection opening and the at least one fluid passage channel lead into the fluid collection chamber.
